(19) United States
(12) Patent Application Publication
(10) Pub. No.: US 2006/0227662 A1
(43) Pub. Date: Oct. 12, 2006

(54) Stretch free trace processing using block move sum and phase-based move out corrected data

(76) Inventor: Richard Foy, Denver, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/369,066

(22) Filed: Mar. 6, 2006

Related U.S. Application Data
(60) Provisional application No. 60/658,908, filed on Mar. 4, 2005.
(60) Provisional application No. 60/658,907, filed on Mar. 4, 2005.

(51) Int. Cl. G01V 1/00

(52) U.S. Cl. 367/52

(57) ABSTRACT

The present invention is directed to generating moveout data for a gather with reduced or substantially eliminated stretch and with improved resolution of potentially overlapping events. In one embodiment, a zero offset trace is obtained and a phase information for the zero offset trace is substituted into phase information for each of the offset traces to perform a phase-based moveout. The zero offset trace may be obtained by a block move sum process and that process may be enhanced for improved resolution of overlapping events. The phase moveout data may be used for analysis of offset dependent relationships such as AVO. Additionally, the phase offset data may be stacked to obtain high signal to noise ratio data for further seismic analysis.

### CROSS REFERENCE TO RELATED APPLICATION

This application claims priority from U.S. Provisional Patent Application Ser. No. 60/658,908, filed on Mar. 4, 2005 and U.S. Provisional Patent Application Ser. No. 60/658,907, filed on Mar. 4, 2005. Both of these provisional patent applications are incorporated herein by reference.

### FIELD OF THE INVENTION

The present invention relates in general to processing of seismic trace data and, in particular, to providing improved normal moveout correction and stacking of a seismic trace gather.

### BACKGROUND OF THE INVENTION

In the field of seismic exploration, a subterranean area of interest is typically imaged by transmitting shots from sound sources and receiving reflected sonic energy at multiple sensors/receivers or ‘geophones’ arranged in an array. The signal received at each geophone defines a trace of seismic data. Each such trace may include a number of features or peaks (also known as reflections and wavelets) corresponding to a number of subterranean reflectors or events.

For a given shot, these peaks occur at different time intervals of the trace generally corresponding to different positions (e.g., depths) of the events and correspondingly different path lengths from the source to the geophones under consideration. Such time delays are not linearly related to the associated change in path length, as signal transmission speeds are spatially dependent.

It will be appreciated that different traces of different geophones include peaks corresponding to the same event. However, these peaks are recorded at different times by the different geophones due to different lateral offsets relative to a reference position such as a common midpoint between source/receiver pairs. That is, different traces (i.e., corresponding to different shots) of different geophones may share a midpoint on the surface that, for each trace, is halfway between its source and its geophone. This common midpoint is vertically above the events recorded in the traces. Theoretically, each trace having a common midpoint should include information regarding the same reflectors/events.

In order to obtain an improved signal to noise ratio, it is desirable to synchronously add a number of traces having a common midpoint such that the peaks corresponding to the same events are temporally aligned and are relatively emphasized whereas noise, which is not expected to be correlated as between traces, will be relatively attenuated. The plot of multiple traces of a common midpoint relative to time and offset axes is termed a common midpoint gather. The pulses corresponding to a single event as detected at various geophones at various offsets from the common midpoint generally define a hyperbolic curve in the gather.

Combining the traces to improve signal to noise ratio generally involves two steps. First, the time frame of the different traces is adjusted to account for the different lateral offsets of the geophones. This is typically accomplished by a process termed normal moveout and results in an “after NMO” plot. This plot generally corresponds to the gather in that it plots the traces against time and offset. However, the time axis, rather than being absolute time, involves NMO adjusted times that are event and offset dependent. The result is that the pulse corresponding to a given event for each geophone is generally aligned with respect to the time axis of the after NMO plot. This after NMO plot is not merely an intermediate step as certain characteristics of the after NMO plot, such as amplitude versus offset information, can yield relevant information regarding subterranean structures of interest.

The second step noted above is stacking. In this step, after NMO data is integrated to yield stacked data having a higher signal to noise ratio. This allows for better identification of events in the presence of noise.

A number of potential problems are associated with this process. First, the plot of different events in one or more traces of a gather may cross. Data at an event crossing point really belongs to two separate events at different NMO corrected times. However, since the NMO process is a single channel process, conventional NMO processes cannot exactly distinguish this data so as to put the data in the correct NMO corrected positions, which result in a smeared event on the after NMO plot. Another potential problem relates to stretching of pulses associated with the NMO correction. As is well-known, conventional processes for NMO correction results in stretching or time widening of certain pulses, particularly pulses corresponding to events at shallow depths as detected at large offsets.

In each of these cases, the problematic data is typically muted or zeroed out. That is, data corresponding to event crossings and data corresponding to shallow events as detected at large offsets is typically muted. The latter process is sometimes referred to as the front-end mute. The result of such muting is a distortion and loss of frequency in the far offsets of the after NMO data and hence the stacked trace.

A number of types of approaches have been proposed to deal with NMO stretching. One type of approach involves defining a number of overlapping time intervals collectively extending from a zero offset time to the end of a near offset or an assumed zero offset trace. For non-zero offset traces, the position of each such time interval is shifted to track the NMO curve. That is, an interval is time translated without any stretching. This results in a single step inversion to zero offset. This may be termed a block move sum process. Such processes avoid NMO stretch but result in a noisier stack. In addition, in such one step, direct from gather to stack processes, an after NMO plot is never developed. As noted above, the after NMO plot yields useful seismic data. Although an after NMO plot can be mimicked, its usefulness as heretofore proposed is limited.

Another type of approach involves phase-based moveout correction. It has been observed that the frequency content of different traces is the same and the traces contain the same events. However, a trace at a greater offset has the events contained in a shorter time span. Since the frequency spectra are the same, the times of the events must be encoded in the phase spectra of the traces. This phase information can therefore theoretically be used to implement moveout correction without stretching of pulses. However, in practice, the different traces cannot be readily shifted to zero offset because no zero offset trace is generally available (and even if available, might be hard to define due to low SNR). Accordingly, it is still necessary to move from the minimum offset trace position to zero offset using conventional NMO techniques. Because this involves defining a zero off-set trace, low SNR can be problematic.

### SUMMARY OF THE INVENTION

The present invention is directed to generating NMO data with reduced or substantially eliminated stretch. The invention thus provides NMO data with reduced distortion and improved frequency content. Such data can be directly analyzed for improved definition of subterranean structure and can be used to generate an improved stack for further analysis. Moreover, the moveout correction of the present invention allows for resolving data associated with trace overlaps so that such data can be usefully mapped to corresponding traces in the after NMO plot. Accordingly, better data is obtained with respect to events that cross at large offsets and improved resolution over a large imaging depth range can be attained for a given seismic imaging array set-up.

In accordance with one aspect of the present invention, a method is provided for using zero offset information obtained via a first moveout correction for use in a second moveout correction, such as a phase-related correction, to obtain moveout corrected data. The associated method includes the steps of receiving a gather including data for multiple events as reflected in multiple traces; using data from multiple traces and a first moveout correction to obtain zero offset information; and using the gather, the zero offset information and a second moveout correction to obtain moveout corrected data. The first moveout correction may involve a block move sum technique that yields zero offset information. The second moveout correction preferably involves a phase-based moveout correction.

In accordance with another aspect of the present invention, moveout for one or more traces (e.g., a gather of CMP traces) is accomplished by using phase information for a zero offset trace. An associated method and apparatus (“utility”) involves obtaining at least a first trace and adjusting a time component of the trace using phase information corresponding to a reference trace having substantially zero lateral offset. The first trace corresponds to a seismic signal detected at a first receiver at a first lateral offset relative to a lateral midpoint between a source of the seismic signal and the first receiver. The reference trace represents a trace or composite information derived from multiple traces associated with a substantially zero offset in relation to the midpoint. In this manner, phase moveout directly to zero offset can be achieved. This allows for moveout substantially without stretch and provides data suitable for analyzing a relationship between amplitude and offset, e.g., AVO. Moreover, a post phase moveout step, e.g., to move from a near offset trace to a zero offset trace, is unnecessary to obtain zero offset data.

The zero offset trace may be obtained by any appropriate methodology. Examples include one parameter moveout processes such as NMO, two parameter moveouts such as dip moveout and three parameter moveouts such as multi-focusing analysis. In one embodiment, a block sum moveout process is used to obtain the zero offset trace. In this regard, a number of overlapping time intervals may be defined relative to a near offset trace or an assumed zero offset trace, and a constant NMO shift is applied to each block of data associated with each time interval so as to avoid or minimize stretch and, consequently, avoid or reduce the need for a front end mute. For enhanced signal to noise ratio, a gather of traces may be moved out in this fashion and then stacked to yield a composite zero offset trace.

Additionally, the moveout may be implemented in a manner that allows for resolution of crossings or instances of events having a time overlap in a trace. Preferably, such resolution allows for apportionment of the amplitude associated with the overlapping events based on the proportional contribution of the component events, rather than even splitting therebetween. In one implementation, this is accomplished based on a mathematical model for estimating the proportional contributions of the component events. Such a mathematical model may, for example, involve reference to other traces. Because different traces include the same events, the contributions of each component event to an overlapping amplitude may be correlated to the amplitudes or relative amplitudes of correspondent events in other traces, e.g., including traces where the events do not overlap. Appropriate constraints can be imposed to reflect this observation.

Further constraints reflect the observation that total energy of the moved out trace (e.g., with resolved overlapping events) is substantially equal to the original trace with the overlapping events. In addition, the mathematical model may involve a constraint requiring maximization of the stacked power (over multiple traces) of each event. These constraints define a Linear Programming System that can be solved to accurately move out all traces of a gather including traces that originally included overlapping events. In this manner, the traces can be moved out and stacked to define a zero offset trace. Having thus demonstrated that a gather can be resolved to yield zero offset trace information, it will be appreciated that other mathematical models may be employed to obtain this information. It is noted that the phase spectrum of the zero offset trace is of primary importance, and the procession to obtain the zero offset trace may be simplified to the extent that the phase spectrum remains sufficiently accurate.

Phase information for the zero offset trace can then be used to perform phase-based moveout of the original, uncorrected gather. In this regard, it has been observed that, for traces at different offsets (excluding spherical spreading and attenuation), each trace contains all events and the frequency content is the same in each trace. Traces at greater offsets simply have the events contained in a shorter time. Accordingly, all information about the arrival times of the events is encoded in the phase spectra of the events. Based on this observation, phase information can be used to implement time shifts corresponding to offset translation. More particularly, because a zero offset trace can be obtained as described above, phase information can be obtained for the zero offset trace and for each other trace in a gather. For example, each of the signals may be transformed from the time domain to the frequency domain as by an FFT while retaining the imaginary components or phase information. The phase information can then be used to moveout an individual trace, multiple traces or all traces of a gather to zero offset, e.g., by substituting the phase spectrum of the zero offset trace into each offset trace. Traces can thereby be stacked to obtain a high quality zero offset trace. Moreover, the moved out traces allow for amplitude versus offset or similar analyses.

### BRIEF DESCRIPTION OF THE DRAWINGS

FIG. 1, illustrates a simplified common midpoint gather of seismic shots.

FIG. 2A, illustrates reflections of traces having different offset sharing a common midpoint.

FIG. 2B, illustrates a NMO correction of the reflections of FIG. 2A.

FIG. 2C, illustrates an integrated stack of the NMOed reflections of FIG. 2B.

FIG. 3, illustrates a common midpoint gather of a multiple stratified geology.

FIG. 4, illustrates the traces of multiple receivers from FIG. 3.

FIG. 5A, illustrates overlapping intervals applied to a zero offset trace.

FIG. 5B, illustrates a close up of the overlapping intervals of FIG. 5A.

FIG. 6 illustrates overlapping intervals applied to an offset trace.

FIG. 7 illustrates the separation of overlapping events in an NMOed trace.

FIGS. 8A-8G illustrate a moveout process in accordance with the present invention including resolution of overlapping events.

FIG. 9 is a flowchart illustrating a phase-based moveout process in accordance with the present invention.

### DESCRIPTION OF THE INVENTION

Two fundamental problems exist with NMO which are usually dealt with by zeroing out (i.e., muting) the regions of affected data:

1. Events that cross at non-near or far offsets

2. NMO stretch

The present invention provides a process that solves both problems without resorting to muting data at the far offsets. The system of the present invention can output the stack trace or the moveout corrected traces from a set of non-NMO corrected gather traces. The system generally involves two processes; 1) defining a zero offset trace and 2) phase-based moveout to zero offset. Each of these is described in turn below.

I. Zero Offset Trace

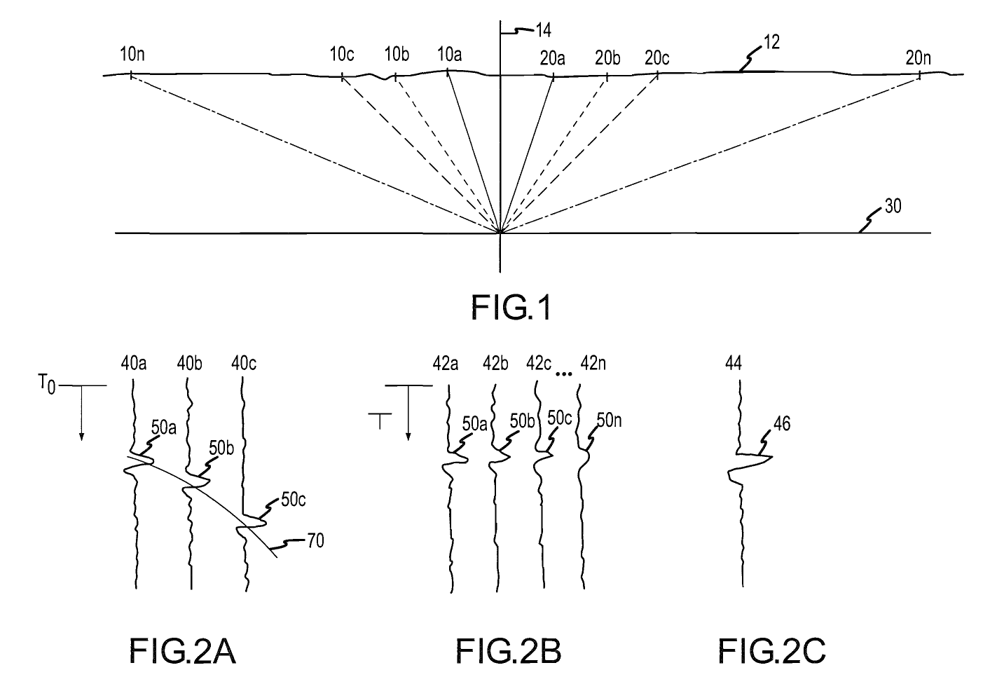

FIGS. 1 and 2 illustrate seismic traces having a common midpoint, move out correction of the traces and stacking of the traces to provide enhanced signal to noise ratio of reflections or ‘events’ within the traces. More specifically, a number of seismic sound sources 10a, 10b and 10c are generated at or below the earth's surface 12. For each sound source generation, a seismic shot of sound travels into the earth and reflects off changes in the geology, which may be termed an event or reflector 30, and is received by the receivers or ‘geophones’ 20a, 20b, and 20c. The geophones 20a-c generates a trace for each shot. As illustrated in FIG. 1, a single event/reflector 30 is shown for purposes of simplicity. However, it will be appreciated that the earth is typically comprised of stratified layers. Boundaries between these layers form an event/reflector. Stated otherwise, the earth is made up of a multitude of different events/reflectors (e.g., 30a-n) and each trace will include a plurality of responses/reflections. Additionally, it will be appreciated that a large number of sources 10a-n and receivers 20a-n (e.g., hundreds or thousands) may be utilized in order to generate a number of traces.

As shown in FIG. 1, a point 14 on the surface 12 is halfway between the multiple sets of sources and receivers 10a-20a, 10b-20b, 10c-20c etc. This point is termed the common midpoint 14 and is vertically above common depth points, or common reflection points (only one shown in FIG. 1). Accordingly, recorded seismic traces 40a, 40b and 40c from the receivers 20a, 20b, and 20c for different sources 10a, 10b and 10c contain information about a common structures located beneath the surface 12 at the common midpoint 14. Accordingly, by stacking these traces 40a-c, enhanced information (including suppressed multiples) about subterranean features may be obtained.

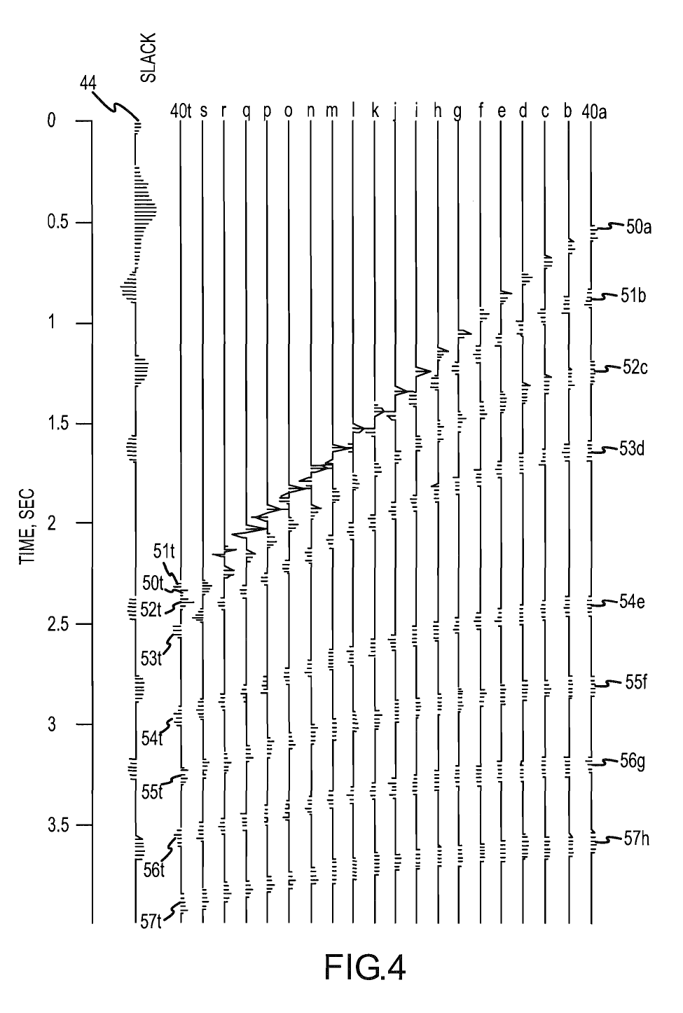

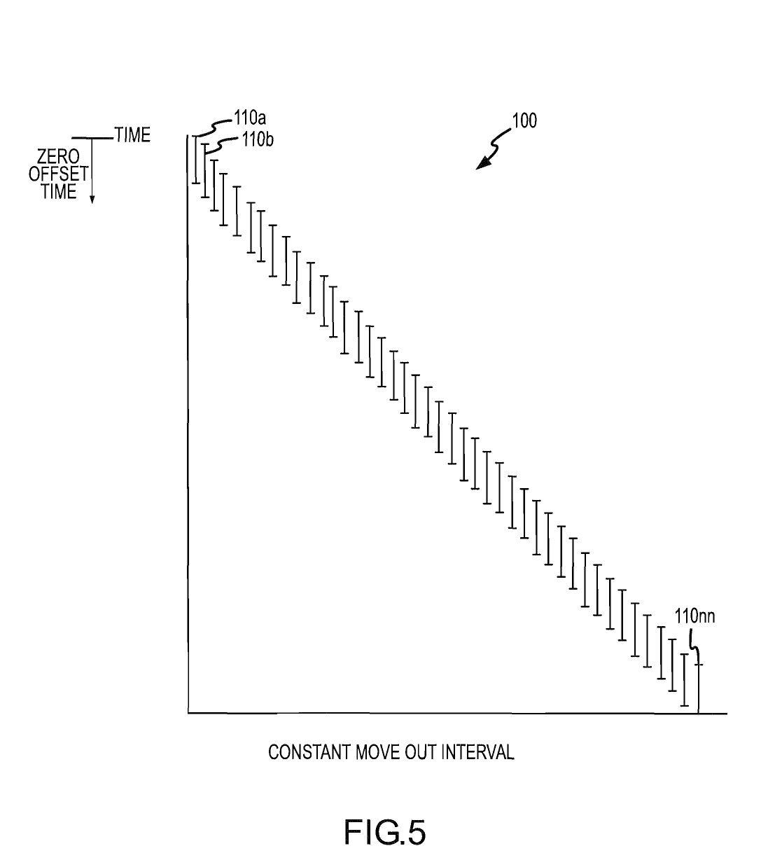

Each receiver 20a-c records seismic energy or signals that return from the interface of contrasting acoustic impedance, which correspond to events/reflectors 30 within the earth. FIG. 2A illustrates the recorded seismic traces 40a-c from the three receivers 20a-c for the common midpoint 14. Each seismic trace 40a-c includes a reflection pulse 50a-c, respectively that corresponds with reflector 30 beneath the earth's surface 14. However, due to the different lateral offsets of the receivers 20a-c from the midpoint 14, the reflection pulses 50a-c within the separate traces 40a-c are not temporally aligned. It will be appreciated that the arrival time of a reflection is based on the distance between a source, a reflector and a receiver and speed of propagation, which may be spatially dependent. In most cases, reflections having the shortest path have the shortest arrival time. As the offset increases between the other sources and receivers (i.e., for a common midpoint) there is an increase in the arrival time of the first reflection in the corresponding trace. As shown, trace 40a has the shortest arrival time relative to Tₒ as the travel path from source 10a to receiver 20a is the shortest. The increased offset between the remaining receivers 20b-n and midpoint 14 results in an increased delay of the reflection pulses 50b-n. As is known in the art, a plot of such array arrival times versus offset is generally hyperbolic in shape (see generally FIGS. 2a and 4). Further, an NMO curve 70 may be generated based on the reflection pulses in a set of traces.

Conventionally, in order to align the reflection pulses 50a-n of the traces 40a-n, which correspond to a common reflector 30, individual traces 40a, 40b and 40c are “normal moveout corrected” or temporally offset such that the reflection pulses 50a, 50b and 50c are aligned to produce a normal moveout (NMO) plot. See FIG. 2B. In this regard, the curve function may be applied to each trace to align the reflection pulses 50a-n. The NMO traces 42a-n are then stacked or summed to produce a stacked trace 44 having an enhanced signal to noise ratio for the combined reflection 52. See FIG. 2C.

A known problem with the above-noted processes for NMO correction relates to stretching of reflection pulses associated with the NMO correction. Particularly reflection pulses corresponding to events at shallow depths as detected at large offsets (e.g., reflection 50n of large offset receiver 20n) are generally stretched or time widened. Typically, reflection pulses in large offset traces associated with deep reflectors (not shown) are less affected. That is, the front-end reflection pulses of large offset traces are generally most affected by NMO stretch. To prevent the stretched pulses at the front end of large offset traces from affecting the stacked trace, the problematic data in each trace is typically muted or zeroed out. This process is sometimes referred to as the front-end mute. The result of such muting is a distortion and loss of frequency in the far offsets of the after NMO data and hence the stacked trace. A detailed discussion of the NMO stretch problem and front-end mute solution is provided in U.S. Pat. No. 6,798,714, which is incorporated by reference herein.

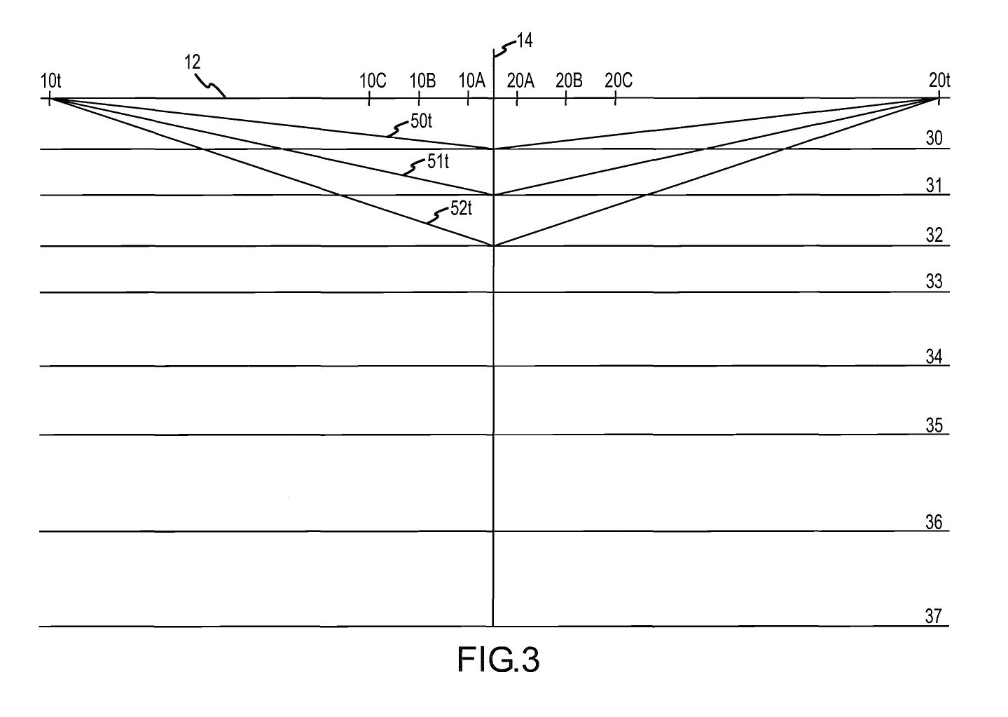

FIGS. 3 and 4 illustrate a more typical common midpoint gather of seismic traces 40a-t where each trace 40a-t includes a plurality of reflections 50-57, which correspond with a plurality of reflectors/events 30-37 below the surface of the earth. Specifically, FIG. 3 illustrates a plurality of sources and receivers for gathering seismic data from a plurality of reflectors while FIG. 4 illustrates the corresponding traces (prior to NMO correction) for each receiver of FIG. 3. As shown, traces (e.g., traces 40a-f) from receivers (e.g., receivers 20a-f) located nearer to the common midpoint 14 include eight separate well-defined reflection pulses 50-57. That is, reflection pulses associated with each subterranean reflector 30-37 are temporally separated in the traces 40a-f of the near offset receivers 20a-f. In contrast, the first, second and in some instances third reflections 50, 51 and 52 of the traces (e.g., 40m-40t) associated with farther offset receivers (e.g., 20m-20t) are minimally separated, overlapped and/or crossed. That is, the front-end reflection pulses 51-53 of the far offset traces are temporally compressed. This phenomenon results from changes in the velocity of sound speed through the earth as a function of depth.

As will be appreciated, the velocity of sound traveling through the earth generally increases as a function of depth. Accordingly, at large offsets receivers (e.g., 20m-20t) reflected energy from deeper reflectors (e.g., 31 and 32) may arrive at a receiver at the nearly the same time and/or prior to the arrival of reflected energy from a shallower event/reflector (e.g., 30). In such instances, the front-end pulses (e.g., 50-52) within a given trace may partially or fully overlap and/or be crossed/transposed. Such overlap and/or transposed reflections often results in what is termed a smear on the seismic trace. Generally, such smears have been accounted for by utilizing muting techniques that remove the compressed/overlapping/transposed reflections (e.g., data) from the trace prior to generating a composite stack. Again, this muting of overlapping and/or transposed data reduces the redundancy in a stacked trace. Accordingly, it is desirable to separate such overlapping and or transposed reflections such that the separated reflections may be utilized to generate a more accurate stacked trace.

The present technique allows for both generating a non-stretched NMO and for resolving overlapping events. The technique utilizes, in part, a block move sum (BMS) technique, such as disclosed in U.S. Pat. No. 6,798,714, which is incorporated herein by reference. The block sum technique approximates ideal inverse NMO better than do certain current industry-standard techniques. It eliminates trace stretching but does not resolve overlapping events (e.g., cross) which contain important amplitude versus offset (AVO) information and contribute to the improvement of signal-to-noise ratio in the stack. Generally the BMS technique works by dividing an assumed zero-offset trace period into a plurality of overlapping time periods or ‘blocks’. The offset traces are likewise divided into the same number of blocks. A time of each block for each offset trace is adjusted along a curve (e.g., hyperbolic curve) associated with the offset traces. This moveout adjusts individual blocks without stretching data within the block. Once the blocks are moveout adjusted, the resulting adjusted traces are summed to generate the zero offset trace.

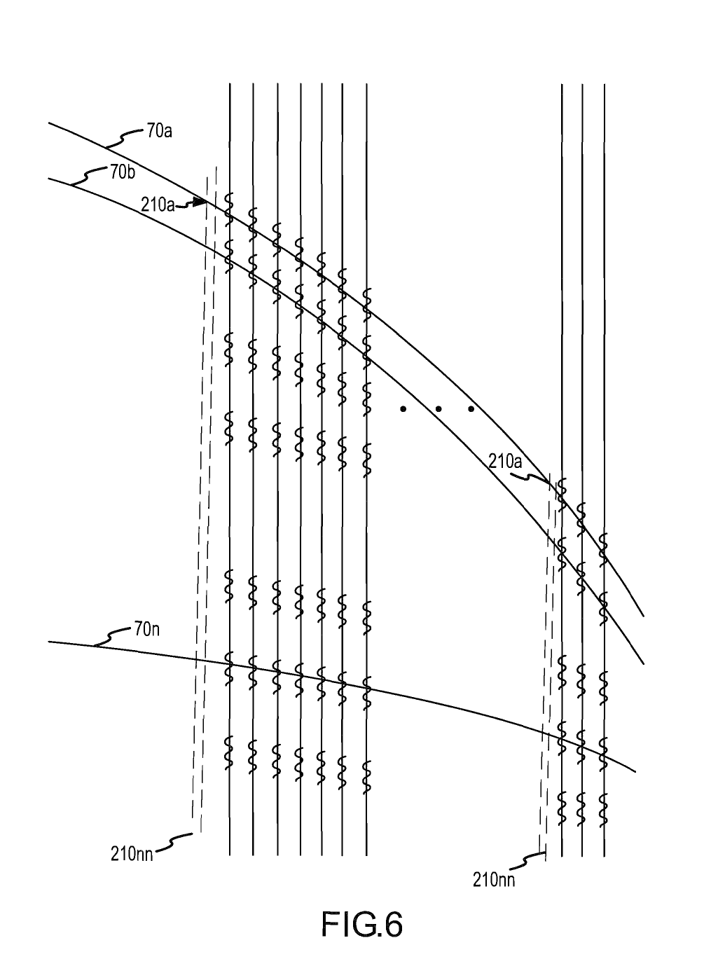

The present model follows this approach in that it divides the zero offset trace (e.g., the stack 44 or in a further arrangement the nearest offset trace) into a series of overlapping data blocks. See FIG. 5. On offset traces, the same data blocks are taken, their center times are adjusted to follow the moveout velocity function. See FIG. 6. However, in the present model, the sum of each set of blocks for a particular trace is constrained to equal the corresponding non-zero offset trace.

As shown in FIG. 5, a putative or assumed zero-offset trace period is divided into a plurality of discrete overlapping time intervals or blocks 110a-110nn. The first block starts at the top of the trace period 100 and the next block begins a fixed increment below the top of the first block 110. The blocks are each of the same duration as illustrated by blocks 110a and 110b. It has been determined that the block duration should accommodate a seismic wavelet, which are typically on the order of 20 ms in length. The blocks continue until the last block reaches the bottom of the trace period 100. Generally, the increment between the overlapping bocks may be selected such that only one or two samples differ between adjacent blocks. That is, the increment and/or duration of the blocks may be based on a sampling rate of the geophones/receivers. In any case, the bocks are strongly overlapping. For each offset trace, the same data blocks 210a-nn are taken. See FIG. 6. As will be appreciated, each trace is a signal (i.e., analog or digital) having an amplitude versus time, which may be represented as a positive or negative number. Accordingly each of the blocks 210a-nn for each trace includes a time series of samples (e.g., amplitudes) associated with their respective trace. In this regard, each block 210a-nn is generally represented as a series of numbers.

A remaining problem is how to divide up a sample that maps to more than one location on the NMOed trace. Certain BMS processes simply average the samples between the overlapping blocks, which suppresses overlapping events. The solution that may be implemented in the present system is to make corresponding blocks on each trace as similar as possible since they represent the same events while at the same time making each set of blocks independent and equal to the current trace. This will unequally divide the samples between the blocks into their respective correct locations.

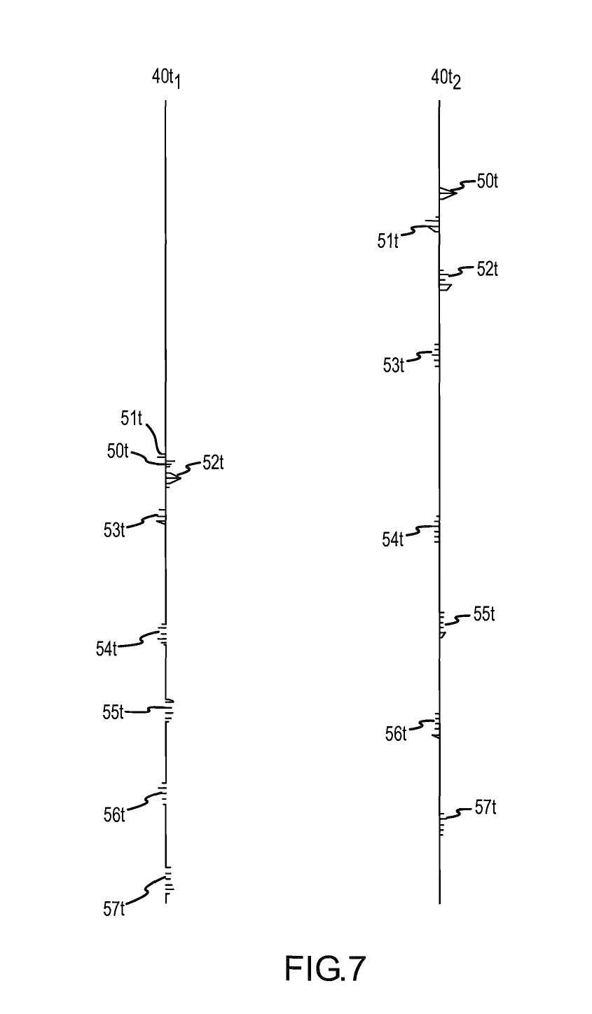

More specifically, the present system is operative to separate overlapping/crossing events in an offset trace such that these events are correctly located in a NMOed trace. After the events are correctly located in an NMOed trace, that trace may be utilized to produce a stacked trace having enhanced resolution. As noted, the system begins with an assumption that corresponding events in different offset traces should be similar as they represent the same features. That is, corresponding events on a common NMO curve 70a-n are similar. See FIG. 6. Likewise, corresponding NMOed blocks of different offset traces should be also similar since they should represent the same events. However, in cases where there is overlap and/or cross, some of the blocks of, for example, the front end of far offset traces are not similar to the corresponding blocks of near offset traces. Accordingly, the technique adjusts the location of the overlapping/crossing events such that they may be properly apportioned to correct locations. Generally, a mathematical model (e.g., a series of linear equations) is generated and resolved to separate the overlapping events. The model includes the constraints that 1) corresponding blocks on all adjusted offset traces be as similar as possible; 2) total energy of each set of blocks for an adjusted offset race be equal to the total energy of the non-adjusted offset trace; and 3) when all blocks are summed along their NMO paths, the power in the total sum is maximized. By solving these equations with these constraints, the energy associated with overlapping/crossing events is apportioned between the blocks of a given trace to its correct location. More specifically, the samples of the overlapping/crossing events will be unequally divided between the blocks to solve the equations according to the constraints. This moves the samples into their respective correct locations. This is illustrated by FIG. 7 which shows trace 40t from FIG. 4 prior to NMO correction and after NMO correction in accordance with the present system. As shown, after resolving the mathematical model while obeying the above-noted constraints, reflection pulses 50t-57t, which in the original offset trace 40t1 are transposed, are reapportioned into the correct order in the NMOed trace 40t₂. That is, reflection pulses 50t and 51t no longer cross or overlap and the energy associated with these pulses may be utilized to generate an improved stacked trace.

To restate, the system maximizes the stack power subject to the constraints that the overlapping blocks sum to give the exact offset traces and that pulses corresponding to the same events on different traces are as similar as possible. Mathematically, this may be represented as follows:
Ax=b,
x>=0

This presents a classic Linear Programming problem. In this case, cx represents the block amplitudes for all traces. As x must be positive but the trace amplitudes can be both positive and negative, we can write the amplitudes as the difference of two positive quantities an=bn−cn for each n.

The quantity maximized is the sum bn+cn. The term ‘a’ is the moveout matrix that spreads the blocks out among the traces. The term ‘b’ represents the offset traces. The maximized objective function, when split up into its component traces and summed, is the stacked trace and the constraints form the NMOed traces. To form each non-stretched moveout corrected trace, we shift each block to its zero-offset time and sum any overlapping blocks

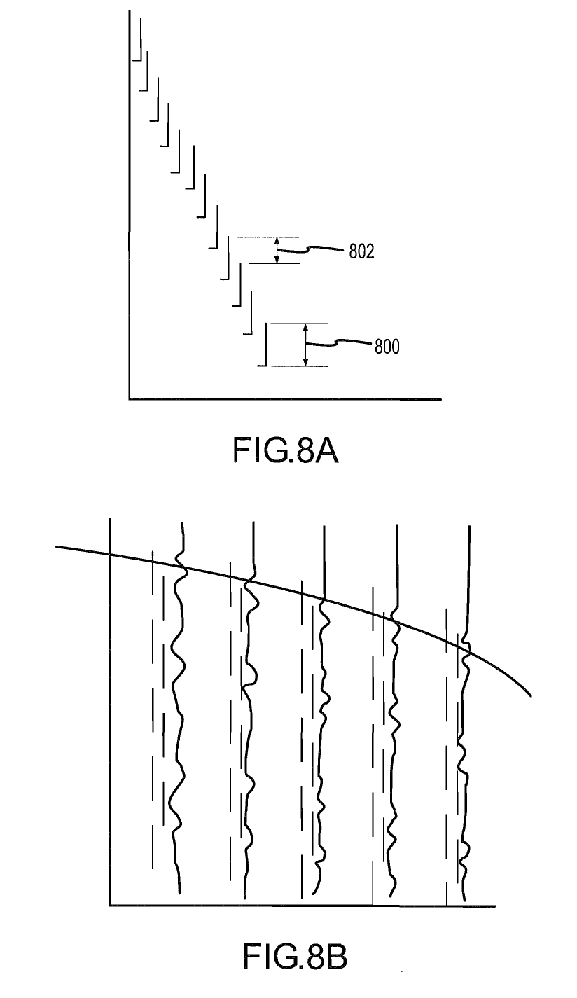

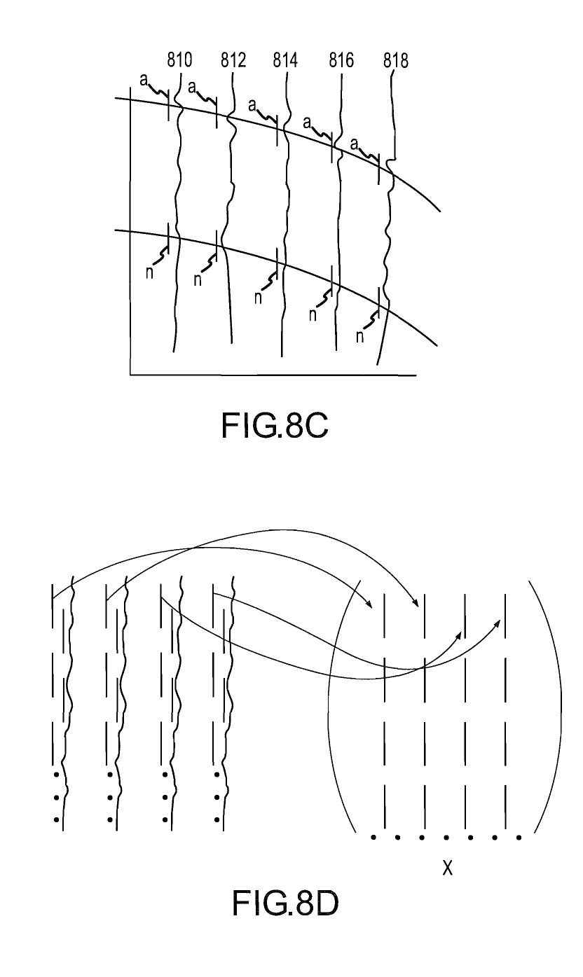

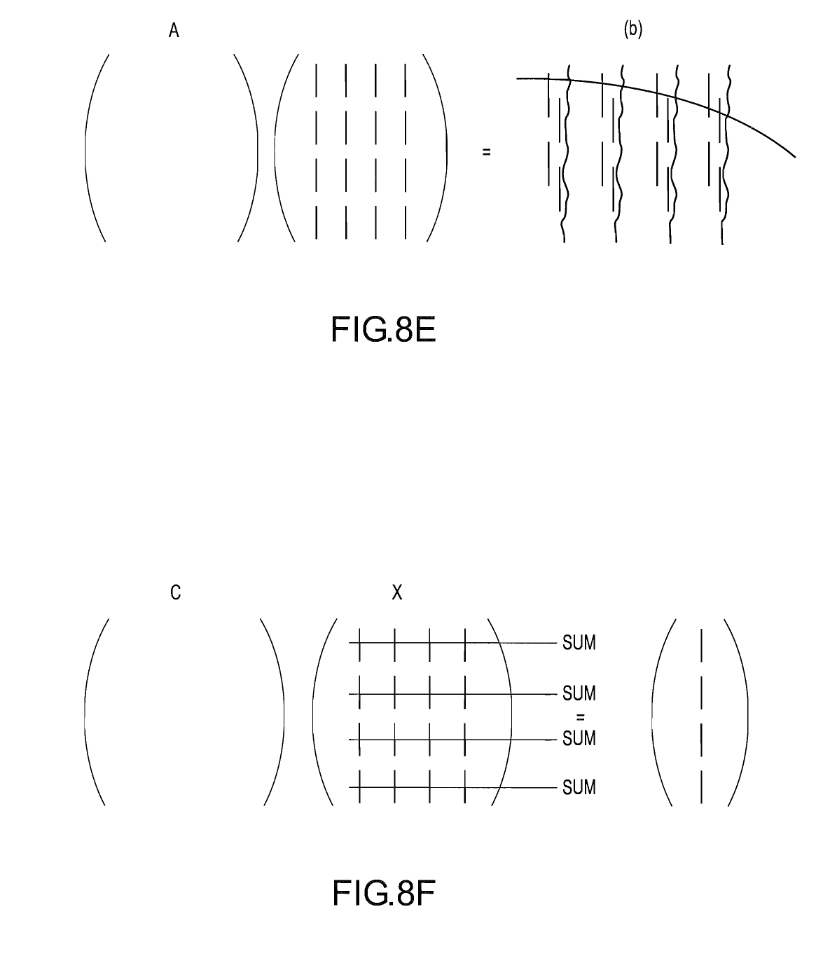

This process may be summarized by reference to FIGS. 8A-8G. First, the length of the blocks 800 and overlap 802 are selected as illustrated in FIG. 8A. These blocks are applied to each trace in an uncorrected gather as shown in FIG. 8B. At this point, there is a set of knowns (the actual prestack offset seismic traces) and a set of unknowns (the amplitudes of the samples in the blocks).

To calculate the amplitudes in the blocks, the following constraints are applied:
1. For each trace, the summation of the overlapping blocks for that trace equals the trace itself.
2. Corresponding blocks on different traces (as shown in FIG. 8C) represent the same data, only with NMO. Accordingly, for each event, corresponding blocks should be as similar as possible (as shown in FIG. 8D).
3. When all the blocks are summed along their NMO patterns, the power in the total sum is maximized.
   As noted above, a Linear Programming System is thus defined. This system is operated to minimize term cx subject to Ax=b where x, c, A, and b are all matrices.
   More specifically, matrix x is the matrix of unknown block samples that the system is solving for as shown in FIG. 8E. Matrix A (FIG. 8F) is the overlapping moveout matrix that maps the block data into their respective locations. This is a known quantity. Matrix b (FIG. 8F) is the known quantity which includes the samples of the prestack seismic traces. Finally, matrix c (FIG. 8G) is the summing matrix for x. This is the matrix that implements the constraint that each said of corresponding blocks is as similar as possible. That is, c causes a horizontal summation of each of the blocks in matrix x. When the blocks are most similar to each other, cx will be maximized.
   Using this Linear Programming System, the uncorrected gather can be processed to provide a moveout corrected gather. This corrected gather is provided without a front end mute and with overlapping events properly resolved. The corrected gather can then be stacked to yield a composite zero offset trace.
   II. Phase-Based Moveout to Zero Offset

As noted above, all information about arrival times is encoded into the phase spectrum of a seismic trace. Accordingly, a time shift corresponding to an offset translation of a trace can be affected by substituting the phase spectrum of a trace at the target offset for the phase spectrum of the trace to be translated. Using the methodology described above, a zero offset trace can be obtained. The following discussion describes how a phase spectrum can be obtained for this zero offset trace, as well as for each offset trace, such that the phase spectrum for the zero offset trace can be substituted for the phase spectrum of each offset trace so as to accomplish phase-based moveout to zero offset.

As is well known, performing a Fourier transform such as an FFT on a time domain signal results in a frequency domain signal having an amplitude component and a phase component. Such an FFT can be performed on the zero offset trace and each of the offset traces. The phase component of the zero offset trace can then be sequentially substituted for the phase component of each of the offset traces to yield shifted frequency domain signals corresponding to each offset trace. These shifted frequency domain signals can then be inverse transformed to yield time shifted traces corresponding to zero offset as indicated by the following equation:
Sⱼ(t)=FFT⁻¹[aⱼ(ω)exp(iρ₀(ω))]
Where j identifies each individual trace within the gather, aⱼ(ω) is the amplitude spectrum of that trace, ρ₀(ω) is the substituted zero offset phase spectrum, and w is the frequency. The result is a phase-based movement gather that is ideal for analysis of relationships between amplitude and offset such as AVO or other offset dependent attributes. Additionally, the phase-based moveout gather can be stacked to yield an enhanced signal to noise ratio zero offset trace for further processing.

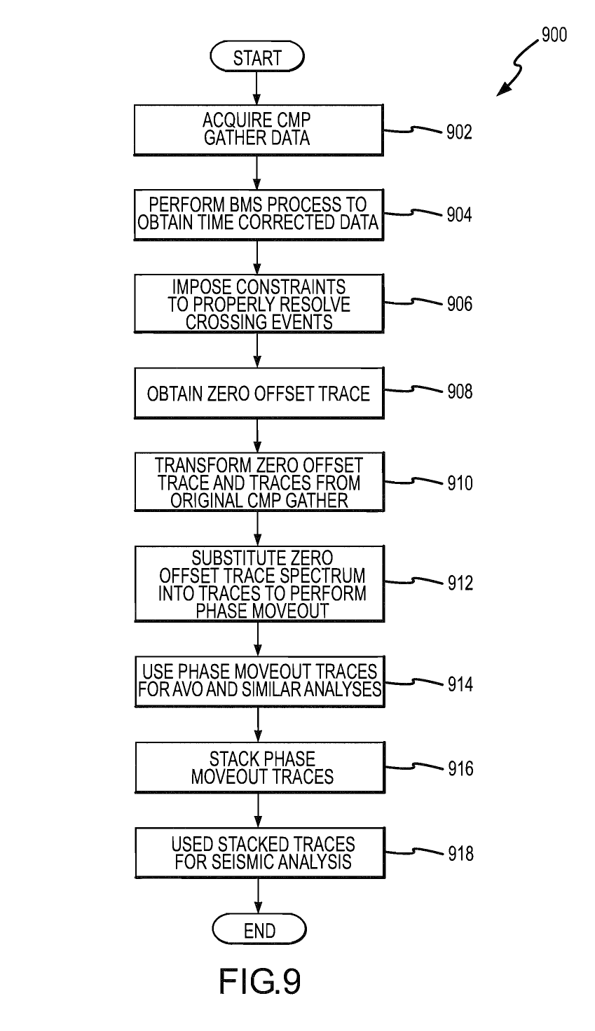

The overall process described above will not be summarized by reference to the flowchart of FIG. 9. The process 900 begins by acquiring (9021) CMP gathered data. As noted above, this may involve establishing an array of source locations and geophones and executing a series of charges at the source locations. A number of traces having a common midpoint may then be collected to obtain a CMP gather.

A block move sum process may then be performed (904) to obtain time corrected data. As discussed in detail above, such a BMS process involves establishing a series of overlapping time intervals, applying the overlapping time intervals to the traces of the uncorrected gather and then moving the data associated with each time interval as a block so as to avoid or minimize stretching. In this manner, a time corrected gather is provided.

As noted above, constraints may also be imposed (906) in connection with this BMS process so as to properly resolve crossing events. Such constraints may involve correlating corresponding events in different traces and causing the moved out trace to be equal to the original trace. A linear programming system can thereby be defined with enables proper mapping of the components of a crossing event to their respective locations in the moved out trace. In this manner, a zero off-set trace is obtained (908). It will be appreciated that a zero offset tract may be obtained without resolving crossing events as discussed above or by any other appropriate methodology.

The zero offset trace and the traces from the original CMP gather can then be transformed (910), as by an FFT process, to obtain spectral data for each trace including a frequency spectrum and a phase spectrum. The zero offset trace spectrum can then be substituted (912) into the offset traces to perform phase moveout. The resulting phase moveout information may be used (914) for AVO and similar analyses involving trace information as a function of offset. Additionally, the phase moveout traces may be stacked (916) and used for (918) for further seismic analysis.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for use in processing seismic data, comprising the steps of:
receiving a gather including data for multiple events as reflected in multiple traces;
first using data from multiple traces and a first moveout correction to obtain zero offset information; and
second using the gather, the zero offset information and a second moveout correction to obtain moveout corrected data.

2. A method as set forth in claim 1, wherein said first moveout correction involves partitioning a first time frame into overlapping first time intervals, applying said first overlapping time intervals to one or more of said multiple traces, and moving data associated with said applied first overlapping time intervals.

3. A method as set forth in claim 2, wherein said moving comprises translating one or more offset traces to a zero offset position.

4. A method as set forth in claim 1, wherein said step of first using is executed before said step of second using.

5. A method as set forth in claim 1, wherein said step of first using comprises resolving potentially overlapping events of at least one of said multiple traces.

6. A method as set forth in claim 1, wherein said step of first using comprises applying, in connection with said first moveout correction, at least a first constraint related to correlating a same event as reflected in different traces and a second constraint related to correlating a same trace before and after said first moveout correction.

7. A method as set forth in claim 1, wherein said second moveout correction is a phase-based moveout correction.

8. As method as set forth in claim 7, wherein said second moveout correction comprises performing a transform on said zero offset information and at least a first offset trace of said multiple traces to obtain zero offset phase information and offset trace phase information and using said zero offset phase information and said offset trace phase information to execute said second moveout correction.

9. As method as set forth in claim 8, wherein said second moveout correction comprises substituting said zero offset phase information for said offset trace phase information.

10. As methods as set forth in claim 9, wherein said second moveout correction involves performing a substitution of said zero offset phase information for phase information of multiple offset traces and obtaining a corrected gather based on said substitution.

11. As methods as set forth in claim 10, further comprising the step of using said corrected gather for an analysis of offset dependent relationships.

12. As methods as set forth in claim 10, further comprising stacking said corrected gather.

13. A method for use in processing seismic data, comprising the steps of:
obtaining at least a first trace corresponding to a seismic signal detected at a first receiver at a first lateral offset relative to a lateral midpoint between a source of said seismic signal and a receiver of said seismic signal; and
adjusting a time component of said at least first trace using phase information corresponding to a reference trace having substantially zero lateral offset relative to said lateral midpoint.

14. A method as set forth in claim 13, wherein said step of obtaining comprises obtaining multiple traces corresponding to multiple signals detected at multiple receivers.

15. A method as set forth in claim 14, wherein said seismic signals detected at said multiple receivers are associated with multiple sources and each of said seismic signals is associated with said lateral midpoint.

16. A method as set forth in claim 14, wherein said step of adjusting comprises adjusting said time component for each of said multiple traces using phase information corresponding to said reference trace.

17. A method as set forth in claim 14, wherein said step of adjusting comprises defining a number of overlapping time intervals that collectively extend across said time dimension of a trace and time-shifting trace data associated with each time interval.

18. A method as set forth in claim 17, wherein said time-shifting comprises using a mathematical model defining differences in arrival times of event data as a function of lateral offset.

19. A method as set forth in claim 18, wherein said mathematical model involves a move-out velocity function.

20. A method as set forth in claim 17, wherein said time shifting comprises shifting said seismic data to a time corresponding to a zero offset trace.

21. A method as set forth in claim 17, further comprising applying said number of overlapping time intervals to a plurality of said traces and time shifting trace data for each of said plurality of traces associated with each time interval.

22. A method as set forth in claim 21, wherein said step of time shifting comprises resolving overlapping events with respect to at least a first trace of said plurality of traces.

23. A method as set forth in claim 22, wherein said resolving comprises unevenly apportioning an amplitude associated with said overlapping events as between a first event and a second event of said overlapping events.

24. A method as set forth in claim 23, wherein said resolving comprises apportioning said amplitude to reflect the relative contributions of said first and second events.

25. A method as set forth in claim 18, wherein said mathematical model involves a constraint that data of corresponding intervals of different traces are similar.

26. A method as set forth in claim 18, wherein said mathematical model involves a constraint that the total energy of the time shifted trace is substantially the same as that of the unshifted trace.

27. A method as set forth in claim 13, wherein said adjusting comprises substituting phase-related information for said reference trace for phase-related information of said at least first trace.

28. A method as set forth in claim 13, wherein said step of adjusting comprises substituting a phase spectrum of said reference trace for a phase spectrum of said at least first trace.

29. An apparatus for use in processing seismic data, comprising:
storage for storing a gather including data for multiple events as reflected in multiple traces; and
a processor for accessing said storage and using said data from said multiple traces together with a first moveout correction to obtain zero offset information;
said processor further being operative for using the gather, the zero offset information and a second moveout correction to obtain moveout corrected data.

30. An apparatus is set forth in claim 29, wherein said processor is operative to execute said first moveout correction by partitioning a first time frame into overlapping time intervals, applying said first overlapping time intervals to one or more of said multiple traces, and moving data associated with said applied first overlapping time intervals based on a mathematical model defining a moveout correction.

31. An apparatus is set forth in claim 30, wherein said moving comprises translating one or more offset traces to a zero offset trace position.

32. An apparatus is set forth in claim 29, wherein said processor is operative for executing said first moveout correction by resolving potentially overlapping events of at least one of said multiple traces.

33. An apparatus is set forth in claim 32, wherein said resolving comprises applying at least a first constraint related to correlating a same event as reflected in different traces and a second constraint related to correlating a same trace before and after said first moveout correction.

34. An apparatus is set forth in claim 29, wherein said second moveout correction is a phase-based moveout correction.

35. An apparatus is set forth in claim 34, wherein said processor is operative for executing said second moveout correction by performing a transform on said zero offset information and at least a first offset trace of said multiple traces to obtain zero offset phase information and offset trace phase information.

36. An apparatus is set forth in claim 35, wherein said second moveout correction comprises substituting said zero offset phase information for said offset trace phase information.

37. An apparatus is set forth in claim 36, wherein said second moveout correction involves performing a substitution of said zero offset phase information for phase information of multiple offset traces and obtaining a corrected gather based on said substitution.

38. An apparatus is set forth in claim 37, wherein said processor is further operative for using said corrected gather for an analysis of offset dependent relationships.

39. An apparatus is set forth in claim 37, wherein said processor is further operative for stacking said corrected gather.
